(19) United States
(12) Patent Application Publication
(10) Pub. No.: US 2005/0125228 A1
(43) Pub. Date: Jun. 9, 2005

(54) Digital electronic correction pen with audio pronunciation and spell check capabilities, with built-in memory. Also calculation processing... thereof...

(76) Inventor: Derrick D. Samuels, Anniston, AL (US)

Correspondence Address: Derrick Samuels, 1518 Cooper Ave, Anniston, AL, 36201, US

(21) Appl. No.: 10/729,187

(22) Filed: Dec. 8, 2003

(51) Int. Cl. G10L 13/08

(52) U.S. Cl. 704/260

(57) ABSTRACT

The digital smart pen has the capabilities to help user pronounce unknown or unfamiliar text, by verbal means. Also, this invention has the operations to do a spell check to text, to assist user in correct spelling of the word or words. Plus, the smart pen has the ability to translate and do basic mathematics by simply scanning the math structure of the problem. This invention can be helpful for students, teachers, or people in mathematic environments.

A digital electronic pen that provides user with pronunciation and spell check capabilities. The smart pen can hold at least 300,000 words inside the CPU by simply scanning the word of choice, the user can receive a verbal response from the pen, or the user can speck into the pen's microphone to request a correct spelling of unknown word. The digital smart pen is useful in and pronunciation, and word meanings if needed.

### BACKGROUND OF INVENTION

1. Field of Invention

The present invention relates to a standard pen having memory capabilities, spell check, and word pronunciation programming.

2. Description of the Prior Art

The digital pen is an electronic instrument that assists the user in word recognition and pronunciation. Within the CPU, the digital pen will store and add digital as needed. Instead of user stopping task, just simply pressing the pronunciation button to access the digital audio network, a verbal response from the user into the digital pen microphone, therefore, a digital verbal response from pen will be spoken. The digital pen will store and transfer any written text into a verbal response, with processing power to save unknown data to its storage unit. The user can continue work without the aid of a dictionary. This invention has the processing power for spell check, with the aid of an electronic spell checker. There exists the need for a quicker response and accessible net-work to check and enunciate unknown words. Also, the digital smart pen does basic math problems (addition, subtraction, division, and multiplication). The user basically scans the said math problem from scanner end locates at the top of the pen and slowly drags the scanner across the printed structure, thus the pen scans the data to come to a mathematical solution. The digital pen has memory to calculate by means of artificial intelligence to process information. There is another pen, which I would like to show the difference between the digital smart pen help user with spell check and pronunciation. The Logitech pen is used with PC set-up and used on PC paper. The digital smart pen is used as a tool to educate the user in a task. Also, the digital pen does not store pages like the Logitech pen. The digital smart pen is used with regular paper, and it has the ability to store new words within the CPU.

Another aspect of this invention is to processing power to enunciate unrecognizable words to the user by 1) By flipping the pen opposite of the tip for writing, 2) then slowly tilt the pen, scan unknown word, with the optical scanner (left to right), 3) release the scan button and the word should appear on the LCD screen, 4) Press the pronunciation button to hear a verbally correct pronunciation of the word. The digital correction pen has the ability to recognize and process words stored inside the CPU; to give real time verbal response to the user.

In another aspect of this invention, it has the ability to perform spell check. The user simply presses the record button, speck clearly and verbally pronounce the word. Also the pen can be about writing distance from the user. The said word will appear on the LCD screen once processing of the word has been found in the CPU. The spell check and pronunciation unit are linked with the LCD screen, thus transmitting the data from the CPU to the LCD module screen.

In another aspect of this invention is the ink sensors, which are inside the ink tube. The purpose of the sensors are to alert the user of low ink or allow user to monitor the level of ink on the LCD screen.

### SUMMARY OF INVENTION

The present invention provides an educational solution to overcome misspelled words, and a word pronunciation, and also provides a mathematically solution to solve and display mathematical answers to math problems. The pen's CPU stores all the data, which is then displayed on the LCD screen. The pen also has an optical scanner that has scanning capabilities to match the words on any print form, and come to an appropriate solution. The said invention has memory and the abilities to add new information to its memory storage. Additionally, this invention has a built-in ink sensor to allow the user to maintain knowledge of ink levels, per use of pen. The optical laser scanning eye, digitally takes a reading of both the math symbol (x, −, +, divided by, and =) icons, and each number in that math structure. Once the digital smart pen has scanned the math problem, a special sound will indicate that the math problem has been processed, thus, the math problem and answer will appear on the LCD screen. A special print to scanner software program will govern these operations of the digital pen. This invention has the ability to store up to 300,000 words within its memory.

In another aspect of this invention, it has the ability to accept e-mails from any telecommunication device, PC, or PDA system. Also, this pen can send out e-mails to these systems mentioned.

In another aspect of this invention, the user no longer has to search for electronic dictionaries or regular dictionaries. This pen allows the user to continue the task with minimum effort or lost train of thought. Also, this invention solves the problem of searching for an electronic calculator to process information, the said invention provides a built-in calculator network system simply by scanning any mathematical problem, and by means of processing the data, the correct answer will appear on the LCD screen.

In another aspect to this invention, the digital smart pen will have the ability to scan common names or punctuation marks, various other features, objects, advantages of the present invention will be detailed from the following description and drawings. Also this present invention has the ability to supply the user with correct word definitions. The digital smart pen has many applications making it useful for education and learning networks.

### BRIEF DESCRIPTION OF THE DRAWINGS

In the drawings:

FIG. 1 is a frontal view illustration the outside parts of the smart pen.

FIG. 2 is an internal view illustration the inter-workings of the digital smart pen.

FIG. 3 is a partial perspective view of one embodiment of the present invention.

FIG. 4 is a frontal block diagram illustration several storage functions of the said invention

FIG. 5 shows a diagram demonstrating the use of the spell check operation.

FIG. 6 shows a diagram demonstrating the different uses the digital smart pen can be used for; besides basic text and math problems.

FIG. 7 shows a frontal view of the correct way to scan text on a level surface.

### DETAILED DESCRIPTION OF PREFERRED EMBODIMENT

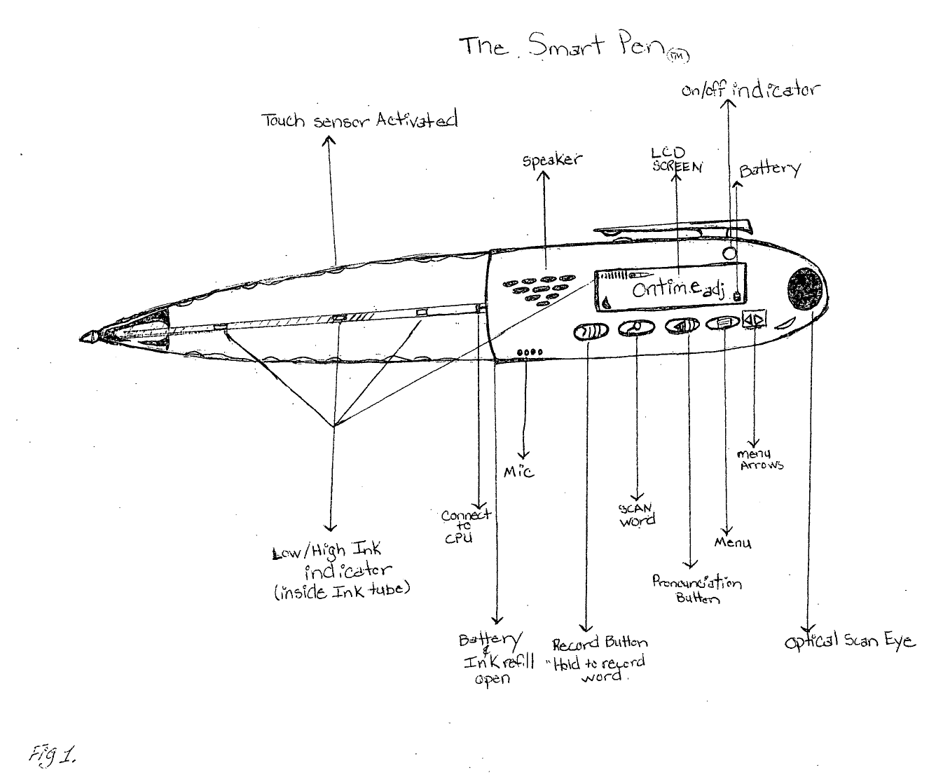

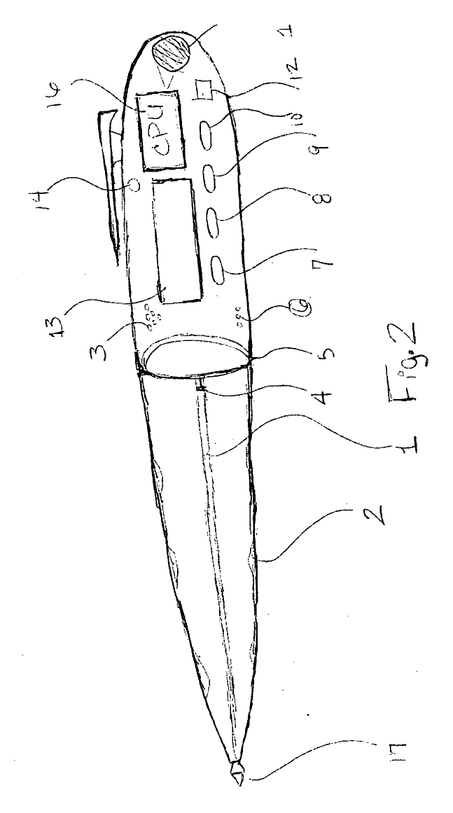

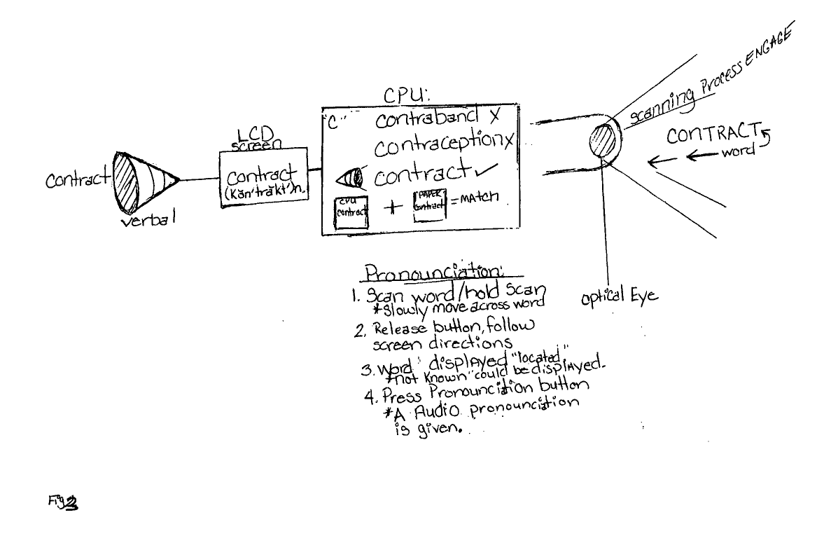

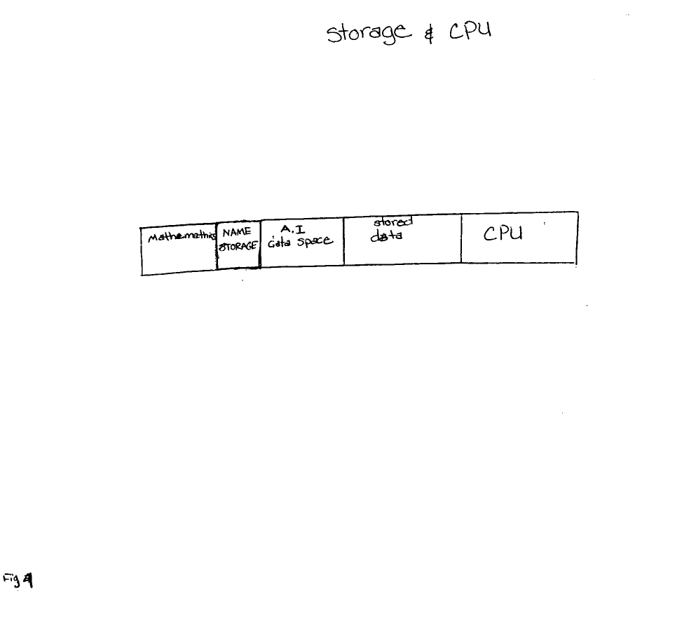

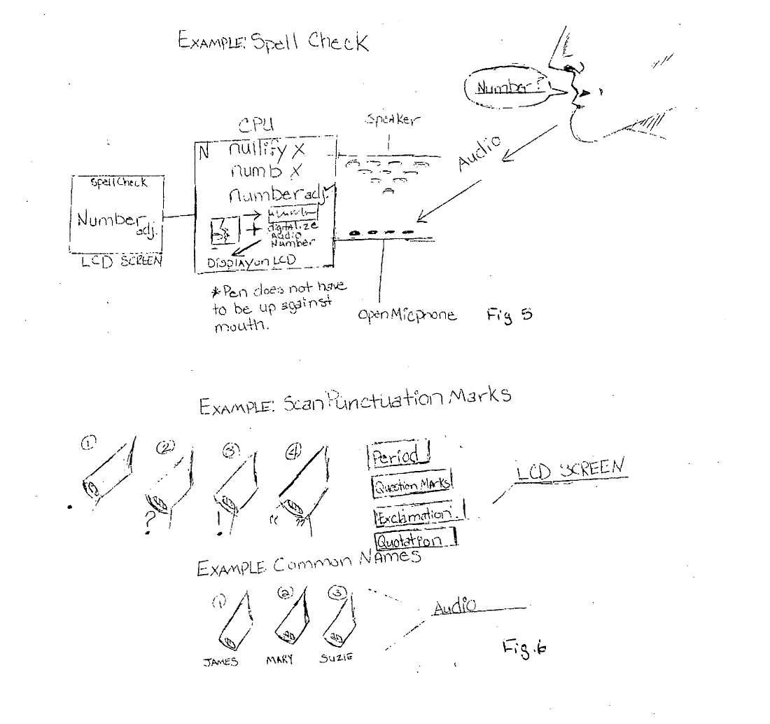

Referring now to FIG. 1, the present invention is intended to provide precise word recognition and pronunciation functions. The present invention comprises of low ink sensor indicator device (1) within the plastic hub. The ink indicator is connected to the central processing unit. Also along the inner hub are touch sensor devices (2) which instantly allows the on/off operation if user desire to program this method of activation. The internal member (3) is near the center of the mentioned invention, and below that is the integrative (6) microphone system that allows the user to input verbal language into the (6) and the said data is transferred to the CPU for word processing, once the information is validated, the user must then release the (7). When the data has been acquired, the user will be notified by a constant beep from the speaker unit. The word will appear on the LCD screen (13) by pressing the (9) button, the user will hear a verbal pronunciation of the word that was scanned.

Referring now to the digital optical laser eye (11). The digital pen optical laser eye record/absorb the word of choice, then a digital response is sent to CPU processing unit, searching for the correct verbal pronunciation match, then by the user pressing the (9) a verbal digital response will be spoke from the (3) unit. The present invention also has the capabilities to spell check data by simply specking into the (6) module. The user must press the (7) and speck clearly in the (6) module, when the word data has been received from the user. The CPU matches the pre-determined data from a verbal command into a digital text command, thus the correct spelling will appear on the (13). This electronic device has the effectiveness to provide a quicker response then known apparatus systems or publication works.

1. A digital electronic pen with the capabilities to recognize or pronunciation printed text to a verbal response.

2. The digital pen claims to do spell check operations by means of user verbal interactions.

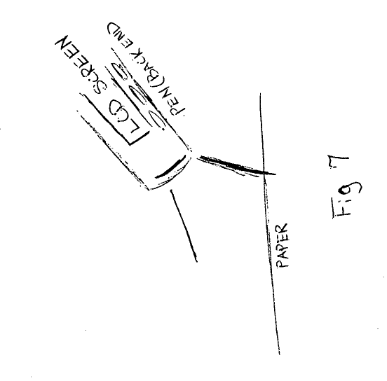

3. The digital pen claims to be able to take a simple math problem in structure and calculate, to provide an answer. See FIG. 7.
